(19) United States
(12) Patent Application Publication
(10) Pub. No.: US 2014/0145413 A1
(43) Pub. Date: May 29, 2014

(54) Brace for providing increased steering stiffness and protection to a front suspension fork

(71) Applicants: Christopher Joshua Baltaxe, Encino, CA (US); Bryson Martin, Castaic, CA (US)

(72) Inventors: Christopher Joshua Baltaxe, Encino, CA (US); Bryson Martin, Castaic, CA (US)

(73) Assignee: Bryson Martin Racing, Inc.

(21) Appl. No.: 13/573,891

(22) Filed: Oct. 12, 2012

(51) Int. Cl. B62K 21/02

(52) U.S. Cl. CPC B62K 21/02
USPC 280/279

(57) ABSTRACT

The invention relates to a front suspension fork stanchion/slider torsion brace structure which attaches to the axle clamp portion of each front fork leg of a two wheeled vehicle whose primary function is to externally resist the legs twisting along the primary steering axis of the fork to reduce flexure of the fork during operation and use by resisting the rotation of the stanchions inside the upper tubes of the fork legs. The added stiffness of the system thus transmits torque to the upper clamps/crowns and maintains perpendicularity between the wheel and the handlebars.

### BACKGROUND OF THE INVENTION

1. Field of the Invention

The present invention generally relates to support for any telescopic suspension product which also doubles as a medium for steering a vehicle, and more particularly to a bracing device to reduce torsional flexure in the telescoping suspension system. The typical applications are for bicycles and motorcycles, both on-road and off-road.

2. Description of the Related Art

The most common embodiments of telescopic suspension products are on bicycles and motorcycles in the form of telescoping suspension forks. This is arranged by two parallel telescoping tubes, which clamp the front wheel axle at their lower extremities and attach to the steering stem of the vehicle through one or two concentric clamps above and below the frame, commonly referred to as “triple clamps”. In these layouts, the smaller set of tubes slide into the larger sealed outer tubes as the suspension cycles. These smaller tubes are commonly referred to as “stanchions”. In this embodiment, a stanchion is one of the telescoping members of a suspension unit. In most modern designs for motorcycles and bicycles, the two fork tubes are located forwards (with respect to the direction of travel) of the steering stem, and the axle centerline is located forwards of the fork tubes. This arrangement is called a “leading axle” design. Enclosed in the fork tubes are various forms of springs, pneumatic, and hydraulic controls which dictate the telescoping motion of the suspension.

There are two common configurations of telescoping suspension fork systems used in mountain bikes and motorcycles. The first is a conventional suspension fork. In this configuration, the clamped upper stanchions slide down into the lower legs. The second is an inverted suspension fork. In this configuration, the lower stanchions slide up into the clamped upper legs. Due to the structural benefits offered by an inverted design fork, it has been the state-of-the-art design for motorcycles where weight savings is less important. Overall stiffness is improved over an un-braced conventional fork. Due to weight constraints with mountain bikes, the designs have propensity towards thin-walled lighter weight chassis which subsequently allow more torsional flex. In these cases, braced, non-inverted conventional forks have become the state-of-the-art.

While the transverse forces are of a significantly higher magnitude on a motorcycle due to the larger vehicle weight and riding speed, steering forces are of similar scale between mountain bikes and motorcycles. As a result, steering flexure and deflection is much higher on a mountain bike chassis due to the lighter weight design with the absence of a brace. Consequently, increased steering stiffness is a desirable trait not presently available on an un-braced lightweight inverted design.

The present invention moves to offer a weight conscious method for increasing steering stiffness in both configurations of telescoping suspension forks. The present invention as applied to both mountain bike and motorcycle suspension systems will offer increased steering stiffness in a lightweight solution, using manufacturing techniques and newly available material combinations to bring a lightweight stiffening brace to inverted and conventional mountain bike suspension forks. The combination of an inverted with relatively light weight and high steering stiffness has not previously been available and will allow users to realize the added performance and chassis benefits of an inverted and conventional telescoping suspension fork without a severe weight increase for the additional stiffness.

Particularly in off-road conditions, the effect of fork twisting or “flexure” (allowing the axle and wheel to twist with respect to the steering axis) can become very apparent to the rider in the form of loss of directional control as the front wheel encounters obstacles, bumps, ruts, or soft soil conditions. With the increase in suspension travel, the problem becomes more obvious as the overall length of the fork increases. It is generally believed that the increased length of the fork legs is the main contributor to torsional flex in the front fork. As force is applied to an object, it deflects a certain amount. As the point at which force is applied departs from the nearest support or constraint, the deflection increases, which is illustrated with the increased deflection causing torsional flex in longer fork legs.

Accordingly, there is a need for improved steering stiffness in telescoping suspension forks without significant addition of weight.

### SUMMARY OF THE INVENTION

To these ends, the present invention generally provides a brace which increases the overall steering stiffness of the system while serving as a protective unit for the front fork. In one preferred embodiment of the invention, it rigidly connects the two axle lugs. As a single structure, it comes in a generally arched shape and couples the torsional forces of one lug to the other and restricts rotational deflection between the stanchion and its respective leg. This system may also be redundantly used as a fork protector.

A second embodiment of the invention pertains to an individual telescoping fork leg, whether it is the only telescoping leg on a vehicle or in a system of multiple parallel legs. In this instance, the present invention provides transfer of torque from the stanchions to the legs thereby increasing the overall stiffness of the system. In this embodiment, an external mechanism would maintain sliding contact with another stationary piece of the fork in order to provide resistance to torsional deflection. This system may also be redundantly used as a fork protector. This embodiment applies to any type of telescoping suspension unit which uses an external means to increase overall steering stiffness of the suspension unit.

The material used for the invention in its preferred embodiment should be carbon fiber composite or some lightweight, rigid material. The ideal layup would be carbon fiber composite/core/carbon fiber composite, which provides the highest ratio of stiffness to weight in torsion about the steering axis of the telescoping suspension fork. The core should be a light density material, with desirable shear strength properties. When used to offset layers of carbon fiber it greatly increases the bending stiffness of the composite. In this embodiment, the cored composite is brought into a cylindrical shape and consequently can withstand high torsional forces.

Carbon-fiber-reinforced polymer or carbon-fiber-reinforced plastic (CFRP or CRP or often simply carbon fiber), is an extremely strong and light fiber-reinforced polymer which contains carbon fibers. The polymer is most often epoxy, but other polymers, such as polyester, vinyl ester, thermoplastic, polyurethane or nylon, are sometimes used. The composite may contain other fibers, such as Kevlar, aluminum, or glass fibers, as well as carbon fiber. The strongest and most expensive of these additives are carbon nanotubes. Although carbon fiber can be relatively expensive, it has many applications, including in modern bicycles and motorcycles, where its high strength-to-weight ratio and very good rigidity is of importance. Improved manufacturing techniques are reducing the costs and time to manufacture. The material is also referred to as graphite-reinforced polymer or graphite fiber-reinforced polymer.

Carbon-fiber-reinforced polymers are composite materials. In this case the composite consists of two parts: a matrix and reinforcement. In CFRP the reinforcement is carbon fiber, which provides the strength. The matrix is usually a polymer resin, such as epoxy, to bind the reinforcements together. Because CFRP consists of two distinct elements, the material properties depend on these two elements. The reinforcement will give the CFRP its strength and rigidity; measured by Stress (mechanics) and Elastic modulus respectively. Unlike isotropic materials like steel and aluminum, CFRP has directional strength properties. The properties of CFRP depend on the layouts of the carbon fiber and the proportion of the carbon fibers relative to the polymer.

Carbon-fiber-reinforced polymer has found use in high-end sports equipment such as racing bicycles. For the same strength, a carbon fiber frame weighs less than a bicycle tubing of aluminum or steel. The choice of weave can be carefully selected to maximize stiffness. The variety of shapes it can be built into has further increased stiffness and also allowed aerodynamic considerations into tube profiles. Carbon-fiber-reinforced polymer frames, forks, handlebars, seat-posts, and crank arms are becoming more common on medium- and higher-priced bicycles. Carbon-fiber-reinforced polymer forks are used on most new racing bicycles.

The benefits of using this particular material, configuration and process include the high ratio of stiffness to weight, the ability to make complex shapes that would otherwise be impossible or impractical with conventional machining methods, and the ability to finely tune flexing characteristics through the material thickness and layup pattern. Other materials may be used for the invention, including plastic, metal, and other composite materials.

Attachment methods of the invention include three distinct methods and four sub methods. The first method of attachment is by way of bolting the brace directly to the fork. The two sub methods for this method of attachment include directly bolting the brace to the fork. The second method of attachment is by interfacing the inner curved surface of the brace leg component to the fork legs with a mating spline or slotted guide set on each leg component or leg member. The two sub methods for this method of attachment include clamping the spline radially, and a combination of clamping the spline and bolting the two components together. A third potential mounting method includes the use of the brace permanently fixed to the dropouts of the fork making the assembly of the stanchions, dropouts, and brace a single rigid member.

The present invention relates to a brace for a front suspension fork assembly for a two wheeled vehicle having a front wheel rotatably mounted on an axle of the wheel, the fork assembly having a pair of upper legs, a pair of lower legs, and a pair of fork dropouts for connection to the axle, the brace comprising first and second rigid leg members, the leg members being generally semi-cylindrical and configured for placement external to and coaxial with first and second lower legs of a suspension fork assembly, wherein the first leg member is substantially parallel with the second leg member; first and second brackets located at lower ends of the first and second leg members, respectively, engageable with first and second dropouts, respectively, on lower ends of the first and second lower legs of the suspension fork assembly; and an arch member having an inverted generally U-shaped configuration for connecting an upper end of the first leg member with an upper end of the second leg member; wherein the brace is slidably engaged axially along a whole length of the front suspension fork assembly. The brace may further comprise a reverse arch member a substantially inverted and generally U-shaped configuration for connecting the upper end of the first leg member with the upper end of the second leg member, the reverse arch member generally extending away from the arch member.

The brace transfers torque from the lower legs of the fork assembly to a steering mechanism of the fork assembly, and increases steering stiffness of the fork assembly by a percentage in the range of five percent (5%) to two hundred percent (200%), preferably by at least one hundred percent (100%). The brace further comprises a guide set comprising first and second guides coupled to lower ends of the first and second upper legs, respectively, of the fork assembly; and first and second rails coupled to inner curved surfaces of the first and second leg members, respectively, of the brace; wherein the first and second rails are respectively slidably engageable with the first and second guides. The inner curved surfaces of the first and second leg members of the brace are interfaced to the fork assembly with a mating spline that is clamped radially. The first and second brackets on the brace comprise through-holes for engagement with bolt means threadingly engageable with the first and second dropouts, respectively, for fixedly and replaceably securing the brace to the fork assembly. The brackets are preferably bonded to the brace, but may optionally be integral with the brace.

Preferably, the brace covers at least a front portion of each of the lower legs of the fork assembly, and is constructed from a material selected from the group of materials consisting of plastic, metal, composites, and carbon fiber composite. Preferably, the brace is constructed of three layers of materials comprising a first outer layer; a core layer; and a second outer layer, wherein the first and second outer layers are constructed of carbon fiber composite, and the core layer is constructed of a light density material. Optionally, the brace may be such that each of the first and second leg members of the brace is constructed as a single integral rigid member with the respective dropout of the fork assembly.

A brace is also disclosed for a front suspension fork assembly for a two wheeled vehicle having a front wheel rotatably mounted on an axle of the wheel, the fork assembly having a pair of upper and lower legs and a pair of fork dropouts for connection to the axle, the brace comprising first and second rigid leg members, the leg members being generally semi-cylindrical and configured to be positioned external to and coaxial with first and second lower legs of a suspension fork assembly, wherein the first leg member is substantially parallel with the second leg member; a guide set comprising first and second guides coupled to lower ends of the first and second upper legs of the fork assembly; and first and second rails coupled to inner surfaces of the first and second leg members of the brace; wherein the first and second rails are respectively slidably engageable with the first and second guides; and an arch member having an inverted generally U-shaped configuration for connecting an upper end of the first leg member with an upper end of the second leg member.

A brace for a front suspension fork assembly for a two wheeled vehicle having a front wheel rotatably mounted on an axle, the fork assembly having a pair of upper and lower legs and a pair of fork dropouts for connection to the axle, the brace comprising first and second rigid leg members, the leg members being generally semi-cylindrical and configured to be positioned external to and coaxial with first and second lower legs of a suspension fork assembly, wherein the first leg member is substantially parallel with the second leg member; and a guide set comprising first and second guides coupled to lower ends of the first and second upper legs of the fork assembly; and first and second rails coupled to inner surfaces of the first and second leg members of the brace; wherein the first and second rails are respectively slidably engageable with the first and second guides.

A front fork reinforcing structure for a two wheeled vehicle having a front wheel rotatably mounted on an axle, the fork assembly having a pair of upper and lower legs, the front fork reinforcing structure comprising first and second rigid rods, the rods being generally cylindrical and attached in parallel respectively with first and second upper legs of the fork assembly, wherein the first rod is substantially parallel to the second rod; first and second upper rod connecting members for connecting upper ends of the first and second rods, respectively, to a pre-determined location on the first and second upper legs, respectively; and first and second lower rod guides secured to upper ends of first and second lower legs, respectively, of the fork assembly for slidable engagement with lower ends of the first and second rods.

The front fork reinforcing structure has first and second lower rod guides comprising through-holes for engagement with bolt means threadingly engageable with the first and second lower legs, respectively, for fixedly and replaceably securing the rod guides to the fork assembly. In addition, first and second rigid rods are preferably constructed from a material selected from the group of materials consisting of plastic, metal, composites, and carbon fiber composite.

A front fork reinforcing structure for a two wheeled vehicle having a front wheel rotatably mounted on an axle, the fork assembly having a pair of upper and lower legs, the front fork reinforcing structure comprising first and second rigid rods, the rods being generally cylindrical and attached in parallel respectively with first and second lower legs of the fork assembly, wherein the first rod is substantially parallel to the second rod; first and second lower rod connecting members for connecting lower ends of the first and second rods, respectively, to a pre-determined location proximate to lower ends of the first and second lower legs, respectively; and first and second upper guides secured to lower ends of first and second upper legs, respectively, of the fork assembly for slidable engagement with upper ends of the first and second rods.

Thus, it is the primary object of the present invention to contemplate and provide a telescoping suspension fork guard providing an external means of increasing the torsional stiffness, and/or decreasing the flexure of the telescoping suspension system.

Another primary objective of the present invention is to provide an external structure to increase total torsional stiffness of the front suspension and steering system.

It is a secondary objective of the present invention to maintain suitable parallelism of the front fork legs with respect to one another and to the steering stem to allow free and unbound movement of each sliding member of the system.

Yet another objective of the present invention is to provide protection from outside elements and impacts to the stanchions of the forks.

Still another objective of the present invention is to prevent breaking, deformation, dislodgement or removal of the torsion guard during impacts from obstacles.

It is yet another objective of the present invention to reduce the potential for permanent bending or deformation of any other member of the suspension and steering system by increasing the stiffness of the whole system if it is struck by an obstacle or encounters extreme force which results in the suspension system twisting about the steering axis.

The above and other aspects, features and advantages of the present invention will become apparent from the following description read in conjunction with the accompanying drawings, in which like reference numerals designate the same elements.

### BRIEF DESCRIPTION OF THE DRAWINGS

A further understanding of the present invention can be obtained by reference to a preferred embodiment set forth in the illustrations of the accompanying drawings. Although the illustrated preferred embodiment is merely exemplary of methods, structures and compositions for carrying out the present invention, both the organization and method of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

For a more complete understanding of the present invention, reference is now made to the following drawings in which:

FIG. 1 shows a front perspective view of a typical bicycle or motorcycle front telescoping suspension fork of an inverted design layout incorporating the torsion brace in accordance with the preferred embodiment of the invention attached to the lower legs of the inverted suspension fork;

FIG. 2 shows an elevated rear perspective view of the front telescoping suspension fork with torsion brace shown in FIG. 1;

FIG. 3 shows a front exploded view of the front telescoping suspension fork with torsion brace shown in FIG. 1;

FIG. 4 shows a front perspective view of the preferred embodiment of the torsion brace in accordance with the invention for use with the lower legs of a front telescoping suspension fork;

FIG. 5 shows a rear perspective view of the preferred embodiment of the torsion brace in accordance with the invention for use with the lower legs of a front telescoping suspension fork;

FIG. 6 shows a top plan view of the preferred embodiment of the torsion brace in accordance with the invention for use with the lower legs of a front telescoping suspension fork;

FIG. 7 shows a front perspective view of a typical bicycle or motorcycle front telescoping suspension fork of an inverted design layout incorporating the torsion brace in accordance with an alternate embodiment of the invention attached to the lower legs of the inverted suspension fork;

FIG. 8 shows an elevated rear perspective view of the front telescoping suspension fork with torsion brace shown in FIG. 7;

FIG. 9 shows an exploded front perspective view of front telescoping suspension fork with torsion brace shown in FIG. 7;

FIGS. 10A-B show front perspective views of an alternative embodiment of the torsion brace in accordance with the invention for use with the lower legs of a front telescoping suspension fork;

FIGS. 11A-B show rear perspective views of the torsion brace shown in FIG. 10A-B, respectively;

FIGS. 12A-B show top plan views of the torsion brace shown in FIG. 10A-B, respectively;

FIG. 13A shows a front perspective view of the upper leg, stanchion and dropout of one leg of a typical bicycle or motorcycle front telescoping suspension fork of an inverted design layout;

FIG. 13B shows side view of the upper leg, stanchion and dropout of one leg of a typical bicycle or motorcycle front telescoping suspension fork of an inverted design layout;

FIGS. 14A-B show the front inverted telescoping suspension fork legs of FIGS. 13A-B, respectively, further illustrating how they are free to rotate independently during longitudinal movement while in use;

FIG. 15A shows a front perspective view of front telescoping suspension fork of an inverted design layout of FIG. 13A with the torsion brace shown in FIGS. 7-12;

FIG. 15B shows a side view of front telescoping suspension fork of an inverted design layout of FIG. 13A with the torsion brace shown in FIGS. 7-12;

FIG. 16A-B show the front inverted telescoping suspension fork legs of FIGS. 15A-B, respectively, further illustrating how they are not free to rotate independently during longitudinal movement while in use;

FIG. 17 shows a front perspective view of a typical bicycle or motorcycle front telescoping suspension fork of a non-inverted design layout incorporating the torsion brace in accordance with a second alternative embodiment of the invention attached to the upper legs of the non-inverted suspension fork;

FIG. 18 shows an elevated rear perspective view of the front telescoping suspension fork with torsion brace shown in FIG. 17;

FIG. 19 shows an exploded front perspective view of front telescoping suspension fork with torsion brace shown in FIG. 17;

FIGS. 20A-B show rear perspective views of a second alternative embodiment of the torsion brace in accordance with the invention for use with the upper legs of a non-inverted front telescoping suspension fork;

FIGS. 21A-B show front perspective views of the torsion brace shown in FIGS. 20A-B, respectively;

FIGS. 22A-B show top plan views of the torsion brace shown in FIG. 20A-B, respectively;

FIG. 23A shows a side view of the lower leg and stanchion of one leg of a typical bicycle or motorcycle front telescoping suspension fork of an non-inverted design;

FIG. 23B shows a front perspective view of the lower leg and stanchion of one leg of a typical bicycle or motorcycle front telescoping suspension fork of a non-inverted design;

FIG. 24A-B show the front non-inverted telescoping suspension fork legs of FIGS. 23A-B, respectively, further illustrating how they are free to rotate independently during longitudinal movement while in use;

FIG. 25A shows a side view of front telescoping suspension fork of a non-inverted design layout of FIG. 23A with the torsion brace shown in FIGS. 17-22;

FIG. 25B shows a front perspective view of front telescoping suspension fork of an inverted design layout of FIG. 23B with the torsion brace shown in FIGS. 17-22;

FIG. 26A-B show the front non-inverted telescoping suspension fork legs of FIGS. 25A-B, respectively, further illustrating how they are not free to rotate independently during longitudinal movement while in use; and

FIG. 27 shows an elevated rear perspective view of a typical bicycle or motorcycle front telescoping suspension fork of an inverted design layout incorporating the torsion brace in accordance with the alternative embodiment of the invention shown in FIGS. 17-22 attached to the lower legs of the inverted suspension fork.

### DETAILED DESCRIPTION OF THE PREFERRED EMBODIMENTS

As required, a detailed illustrative embodiment of the present invention is disclosed herein. However, techniques, systems, compositions and operating structures in accordance with the present invention may be embodied in a wide variety of sizes, shapes, forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein which define the scope of the present invention.

Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, up, down, over, above, below, etc., or motional terms, such as forward, back, sideways, transverse, etc. may be used with respect to the drawings. These and similar directional terms should not be construed to limit the scope of the invention in any manner.

### LISTING OF REFERENCE NUMERALS

brace 1
fork dropouts 2
upper tubes 3
lower crown or clamp 4
upper crown or clamp 5
steerer tube 6
axle 7
bracket 8
bolts 9
stanchions 10
brace 11
fork dropout 12
bolts 13
guide 14
upper leg 15
bolts 16
rail 17
bolts 18
axle 19
upper crown or clamp 20
steerer tube 21
lower crown or clamp 22
stanchions 23
fork legs 24
axle 25
lower crown or clamp 26
crowns or clamps 26 and 28
steerer tube 27
boss 29
torsion brace 30
rod connecting end 31
guides 32
rear inverted U-shaped arch portion 33
front inverted U-shaped arch portion 34
bore holes 35
brace inner edge 36
brace outer edge 37
brace outer surface 38
brace inner surface 39
bracket 40
bore through hole 41
brace outer surface 42
brace inner surface 43
bore through hole 44
brace lower end 45
axle bore through hole 46
rod 47

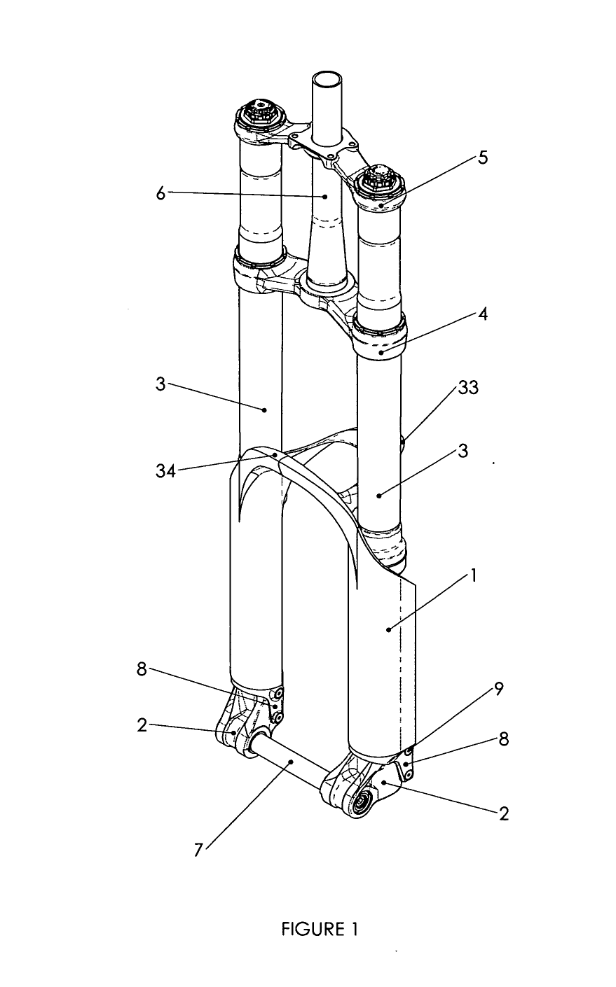

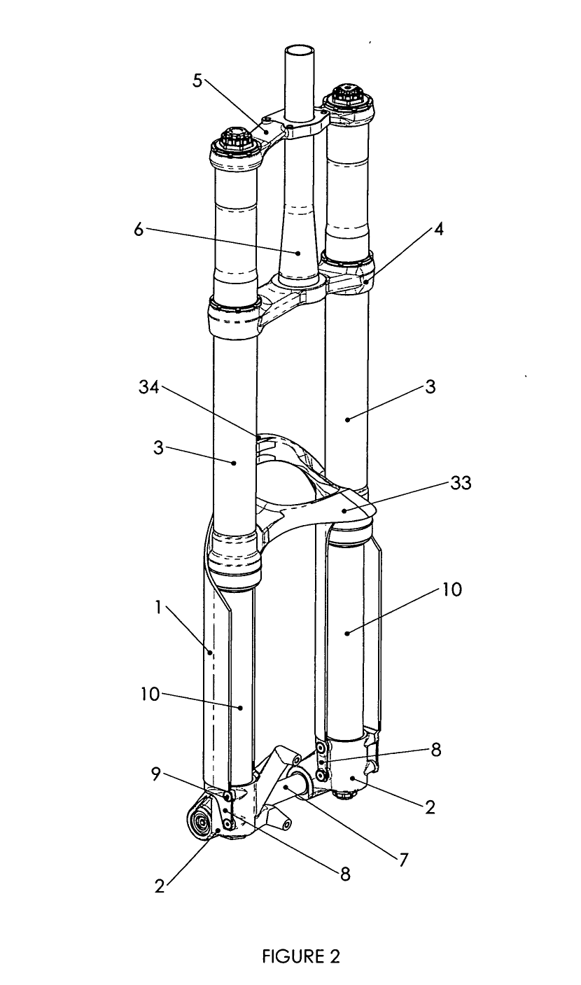

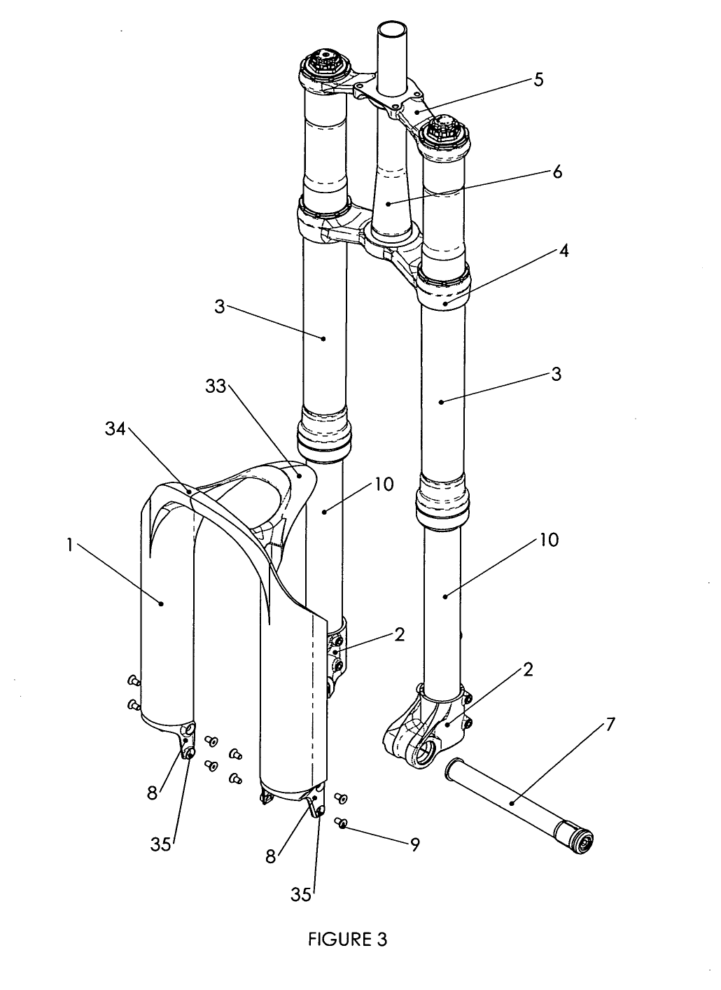

Referring first to FIGS. 1-3, shown are views of a typical bicycle or motorcycle front telescoping suspension fork of an inverted design layout incorporating the torsion brace 1 in accordance with the preferred embodiment of the invention attached to the lower legs of the inverted suspension fork. In particular, shown is the preferred embodiment of torsion brace 1 attached to the fork dropouts 2 through a bracket 8 with bolts 9 according to the invention. As in conventional inverted suspension forks, the fork dropouts 2 clamp the axle 7 and prevent the stanchions 10 (see FIG. 2) from rotating in the upper tubes 3. The combined assembly of the stanchions 10, dropouts 2, brace 1, brackets 8, bolts 9, and axle 7 slide upward such that stanchion 10 slides into the upper tubes 3 during the suspension cycle while brace 1 slides upward around upper tubes 3.

During assembly of the suspension fork, the upper crown 5 typically bolts to the upper tubes 3 and the steerer tube 6, which usually comes pre-assembled with the lower crown 4, also typically bolted to upper tubes 3 and steerer tube 6. This ensures that the upper tubes 3 are parallel with one another and are at equal height within the crowns 4, 5. Also during assembly, the brace 1 can be installed to keep the stanchions 10 aligned and parallel to be concentric and co-axial with upper tubes 3. In addition, the brace 1 keeps the axle slots and bolt slots 35 concentric and co-axial with one another. Also, axle 7 may be installed and clamped into the dropouts 2 for the same purpose. The fork dropouts 2 typically but not always come bonded to the stanchions 10.

In the preferred embodiment, the brace or front fork reinforcing structure 1 is integral with or bonded to the mounting brackets 8 at the lower end of its legs. To assemble, the mounting brackets 8 are preferably bolted to the fork dropouts 2 by using the bolts 9. Other means of securing brackets 8 to fork dropouts 2 may be used as well. It is through this interface that the stanchions 10 are able to resist rotation inside the upper tubes 3 and reduce the overall flexure of the fork assembly from fork assemblies where the brace 1 and the brackets 8 are not installed. The bolts 9 may be positioned at any orientation and spacing with respect to the assembly, and the orientation and spacing will determine how much of the overall flexure over the fork is reduced. Similarly, the size and shape of the brackets 8 may be of various configurations and will also determine how much of the overall flexure over the fork is reduced. The result is that the brace 1, brackets 8, dropouts 2, and stanchions 10 can be regarded as a singular member, with the external brace 1 acting to stiffen the entire system through this singular member during compression and steering.

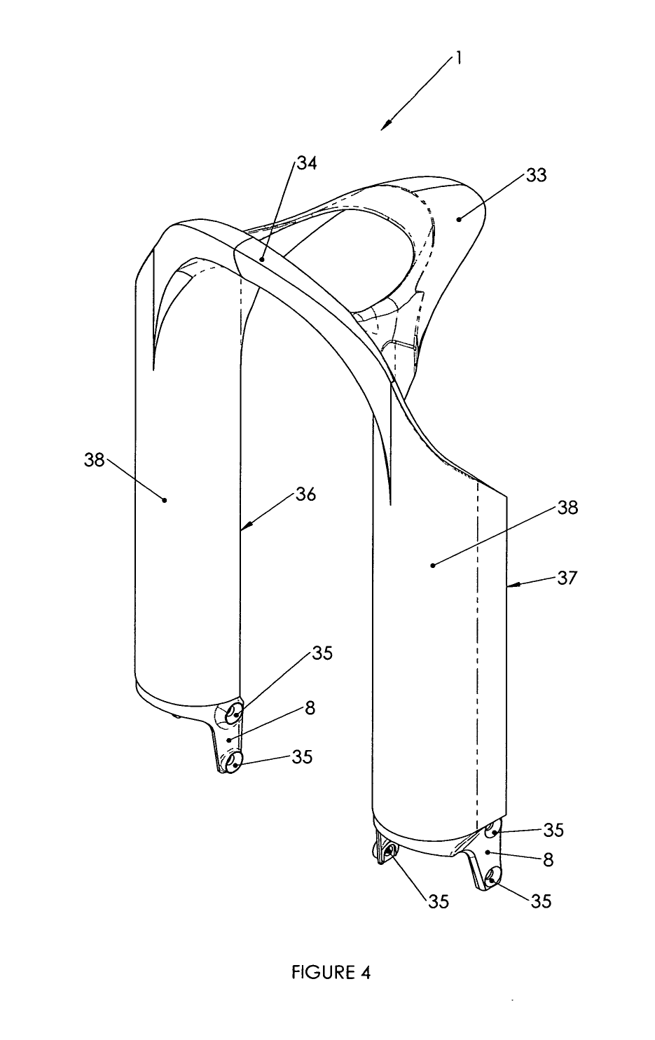

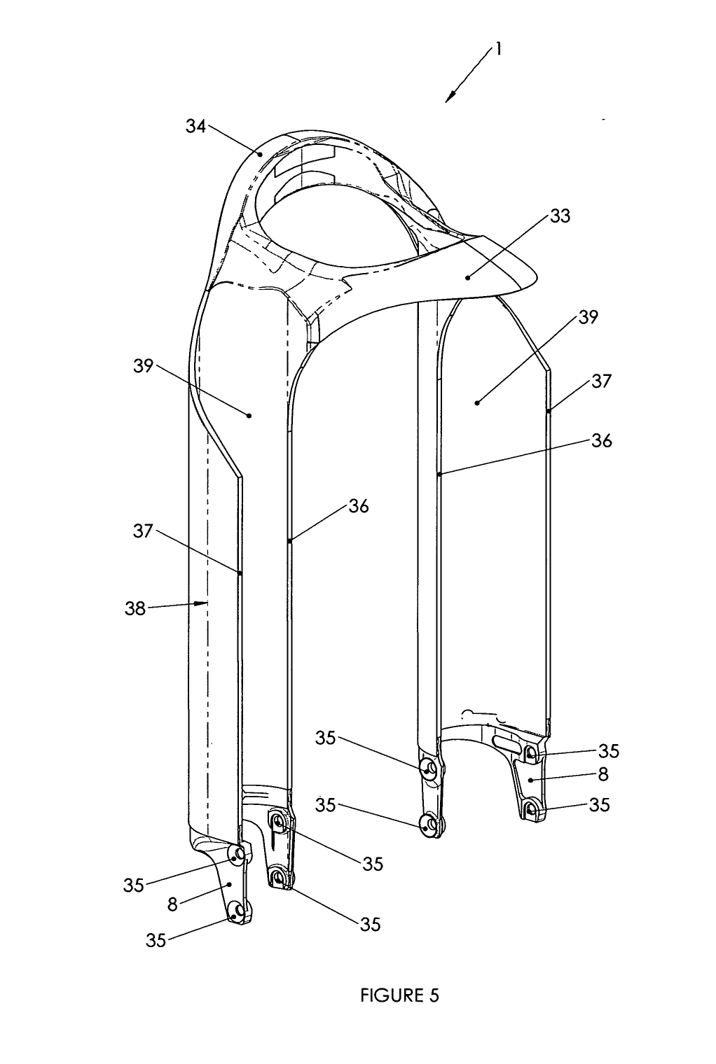

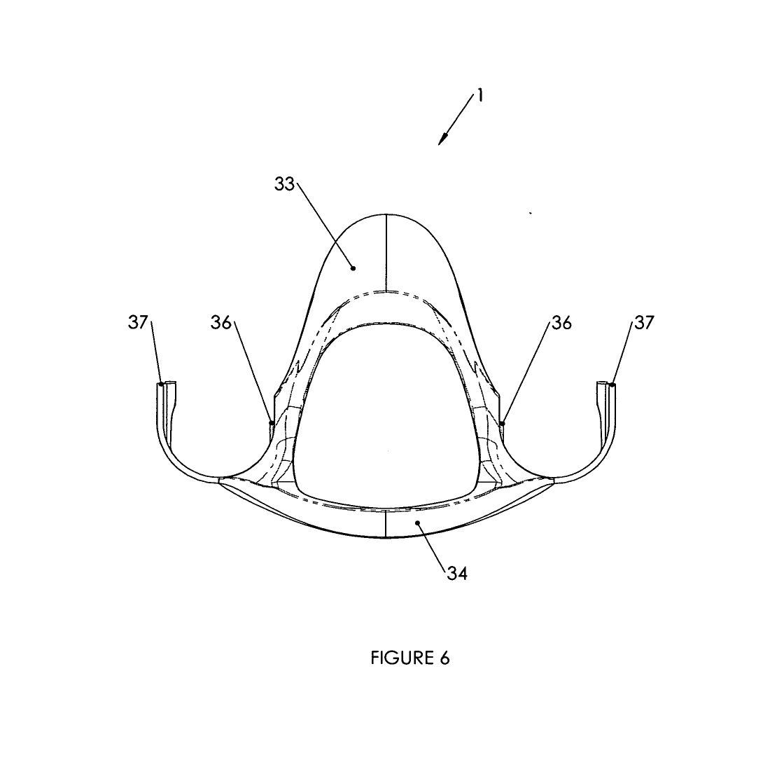

Looking at FIGS. 4-6, shown are enlarged views of the preferred embodiment of the torsion brace 1 in accordance with the invention for use with the lower legs of an inverted front telescoping suspension fork (as depicted in FIGS. 1-3). Preferably, brace 1 is configured with a pair of substantially parallel and semi-cylindrical legs having outer surfaces 38, inner surfaces 39, inner edges 36 and outer edges 37. Also, integral with or bonded to the lower end of each leg of brace 1 are brackets 8 each having a plurality of bore through holes 35 for lugs or bolts 9 to attach or secure bracket 8 and brace 1 to fork dropouts 2.

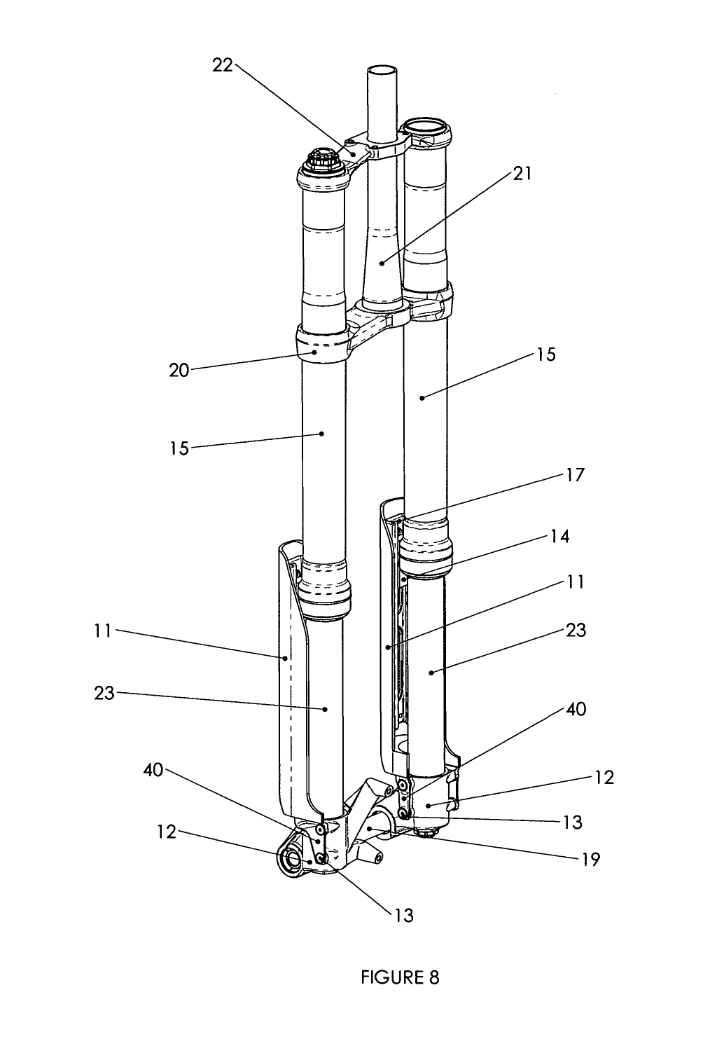

The substantially semi-cylindrical legs of brace 1 are preferably sized such that they slide along the outside of upper tubes 3 (see FIGS. 1-2) of the fork assembly. Preferably, the upper end of the legs of brace 1 are connected via front inverted U-shaped arch portion 34 and rear inverted U-shaped arch portion 33. Front and rear arch portions 34, 33 preferably provide additional stiffness to brace 1 and aid in the reduction of flexure of the fork during operation and use. Optionally, for additional support, brace 1 may be provided with a slotted guide set (not shown along with this embodiment) such as the one depicted in conjunction with the alternative embodiment illustrated in FIGS. 8, 9 and 11 and referenced by numerals 14 and 17. In still another alternative embodiment, brace 1 may be provided solely with a slotted guide set (not shown along with this embodiment) such as the one depicted in conjunction with the alternative embodiment illustrated in FIGS. 8, 9 and 11 and referenced by numerals 14 and 17 for attachment to the fork assembly and not have bracket 8.

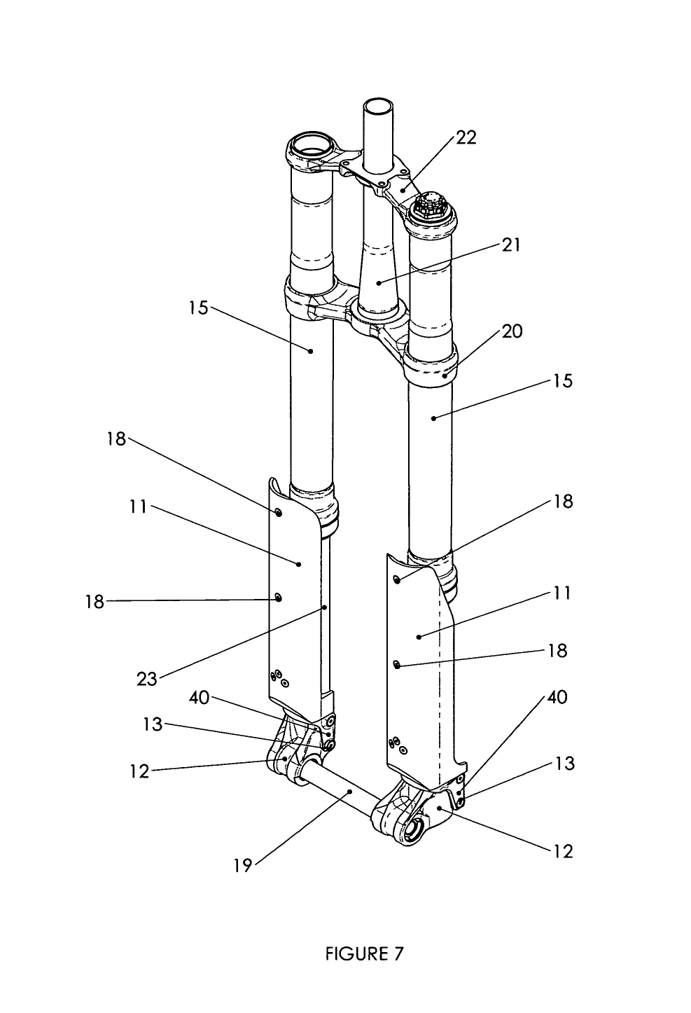

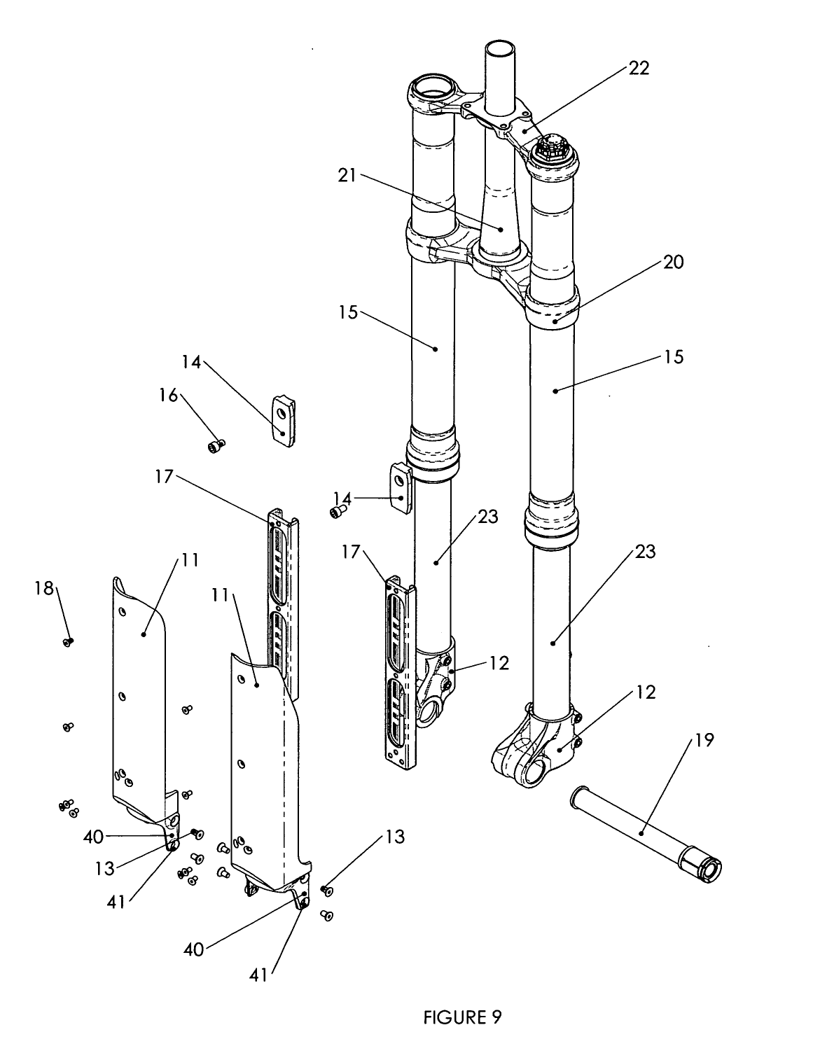

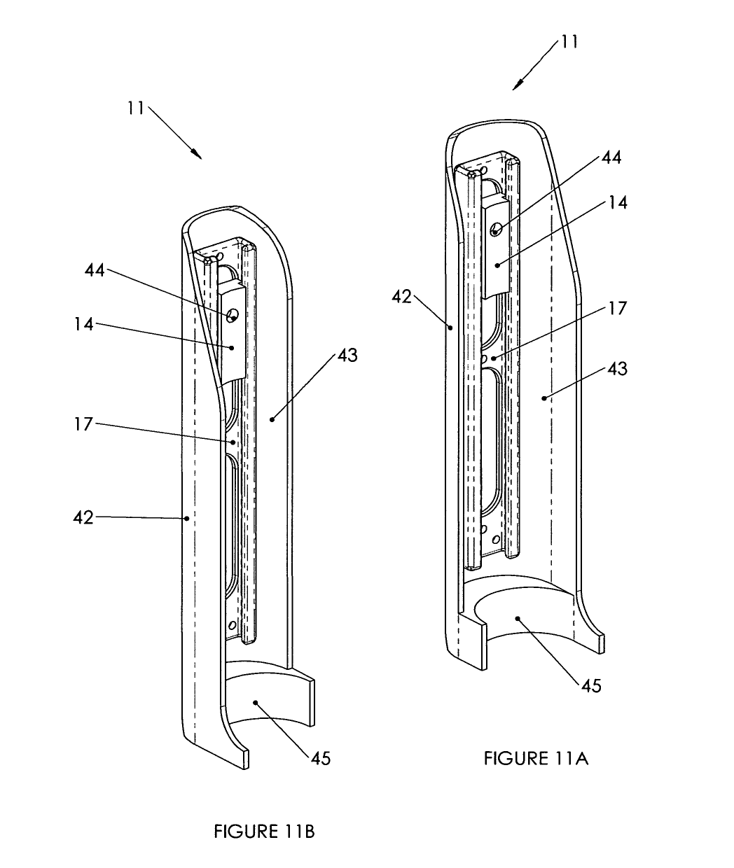

Turning next to FIGS. 7-9, shown are views of a typical bicycle or motorcycle front telescoping suspension fork of an inverted design layout incorporating the torsion brace or front fork reinforcing structure 11 in accordance with an alternate embodiment of the invention attached to the lower legs of the inverted suspension fork. In particular, in this alternative embodiment the brace 11 preferably comprises two independent leg components that each mount independently to each fork dropout 12 with bolts 13. A guide 14 (see FIG. 9) is attached to the upper leg 15 with bolt 16 and slides along a rail 17 on the inside edge of the brace 11, which is held on to the inner surface 43 (see FIG. 11A-B) of brace 11 with bolts 18. As in conventional inverted suspension forks, the fork dropouts 12 clamp the axle 19 and prevent the stanchions 23 (see FIG. 8) from rotating in the upper tubes 15. The combined assembly of the stanchions 23, dropouts 12, brace 11, brackets 40, bolts 13, and axle 19 slide upward such that stanchions 23 slide into the upper tubes 15 during the suspension cycle while each brace 11 slides upward around each upper tube 15. This arrangement transfers torque from the axle 19 to the upper legs 15, lower crown 22, steerer tube 21, and upper crown 20 and resists rotational deflection between the stanchions 23 and the upper legs 15 in the same manner as the previous embodiment.

As discussed above, during assembly of the suspension fork, the upper crown 22 typically bolts to the upper tubes 15 and the steerer tube 21, which usually comes pre-assembled with the lower crown 20, also typically bolted to upper tubes 15 and steerer tube 21. This ensures that the upper tubes 15 are parallel with one another and are at equal height within the crowns 20, 22. Also during assembly, the brace 11 can be installed to keep the axle slots and bolt slots 41 concentric and co-axial with one another. Also, axle 19 may be installed and clamped into the dropouts 12 for the same purpose. The fork dropouts 12 typically but not always come bonded to the stanchions 23.

Also, in this alternative embodiment, it is preferred that each brace 11 be integral with or bonded to the mounting brackets 40 at its lower end. To assemble, the mounting brackets 40 are preferably bolted to the fork dropouts 12 by using the bolts 13. Other means of securing brackets 40 to fork dropouts 12 may be used as well. It is through this interface that the stanchions 23 are able to resist rotation inside the upper tubes 15 and reduce the overall flexure of the fork assembly from fork assemblies where the brace 11 and the brackets 40 are not installed. The bolts 13 may be positioned at any orientation and spacing with respect to the assembly, and the orientation and spacing will determine how much of the overall flexure over the fork is reduced. Similarly, the size and shape of the brackets 40 may be of various configurations and will also determine how much of the overall flexure over the fork is reduced. The result is that the combination of each brace 11, bracket 40, dropout 12, and stanchion 23 can be regarded as a singular member, with each external brace 11 acting to stiffen the entire system through this singular member during compression and steering.

With specific reference to FIGS. 9 and 11, illustrated is slotted guide set 14, 17, which movably connects brace 11 with the fork assembly allowing for longitudinal movement during compression of the suspension fork assembly. Slotted guide set comprises rails 17 affixed to each inner surfaces 43 of braces 11 and guides 14 secured or affixed to the lower end of upper legs 15 with bolts 16 via bore holes 44. During operation or use of the suspension fork assembly, when compressed, rails 17 slide longitudinally along the respective guides 14 and additionally reduce flexure of the fork during operation and use by aiding in the resistance of the rotation of the stanchions inside the upper tubes 15.

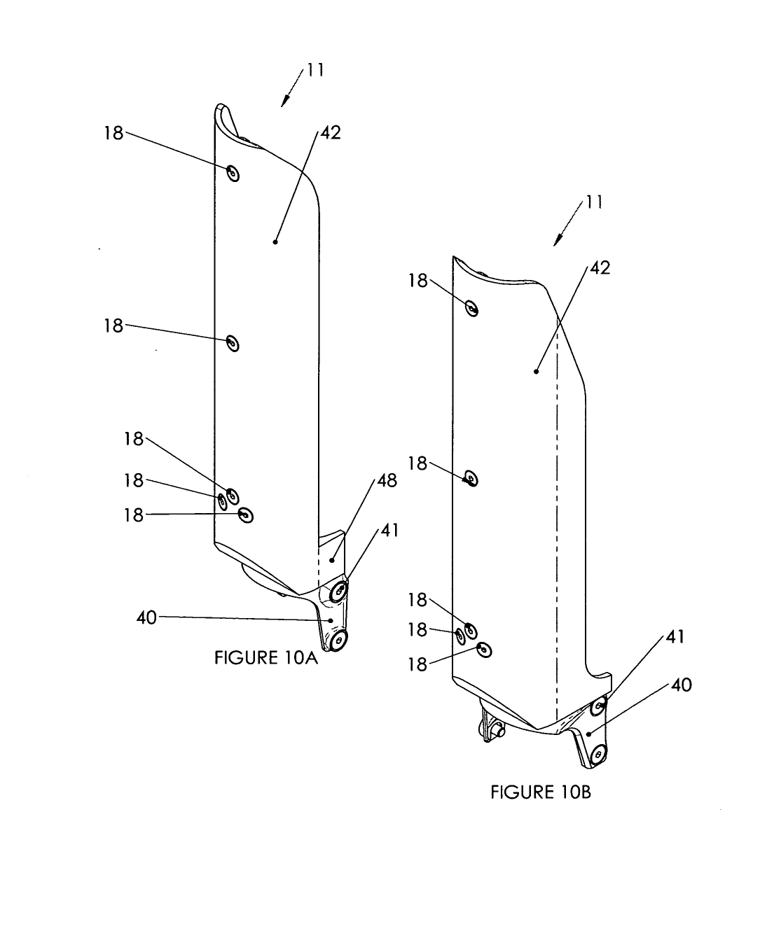

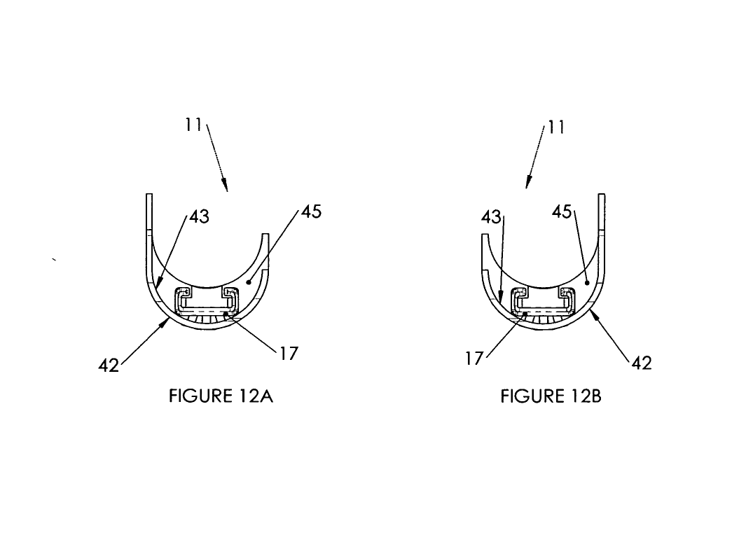

Looking now at FIGS. 10-12, shown are enlarged views of the alternative embodiment of the components for torsion brace 11 in accordance with the invention for use with the lower legs of an inverted front telescoping suspension fork (as depicted in FIGS. 7-9). As shown, this embodiment of brace 11 is preferably configured as a pair of substantially parallel and substantially semi-cylindrical independent legs having outer surfaces 42, inner surfaces 43 and thickened brace lower end 45. The substantially semi-cylindrical legs of brace 11 are preferably sized such that they slide along the outside of upper tubes 15 (see FIGS. 7-8) of the fork assembly. The optional increased thickness of the lower end 45 of each brace 11 is designed to aid in the support of the attachment of each brace 11 to each for dropout 12 of the fork assembly. Also, optionally, as seen in FIGS. 7-9 but not in FIGS. 10-12, integral with or bonded to the lower end of each leg of brace 11 are brackets 40 each having a plurality of bore through holes 41 for lugs or bolts 13 to attach or secure bracket 40 and brace 11 to fork dropouts 12. Of course, as would be appreciated by one of skill in the art, it is contemplated by the invention that only one brace on only one fork leg of the suspension fork assembly according to any of the embodiments disclosed herein is necessary to achieve the increased steering stiffness or torsional stiffness as contemplated by the invention, the corresponding reduction in flexure of the suspension fork assembly.

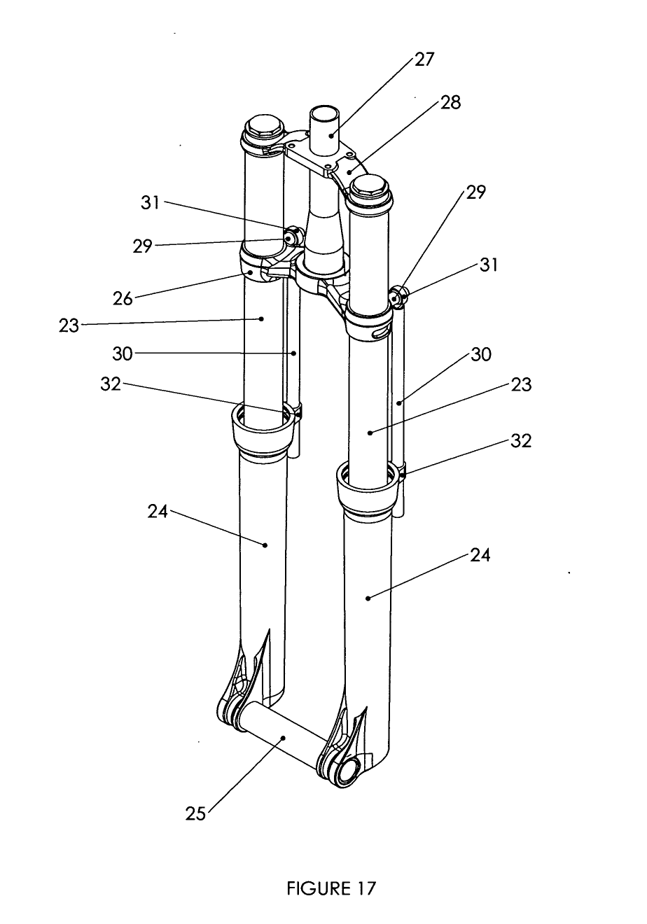

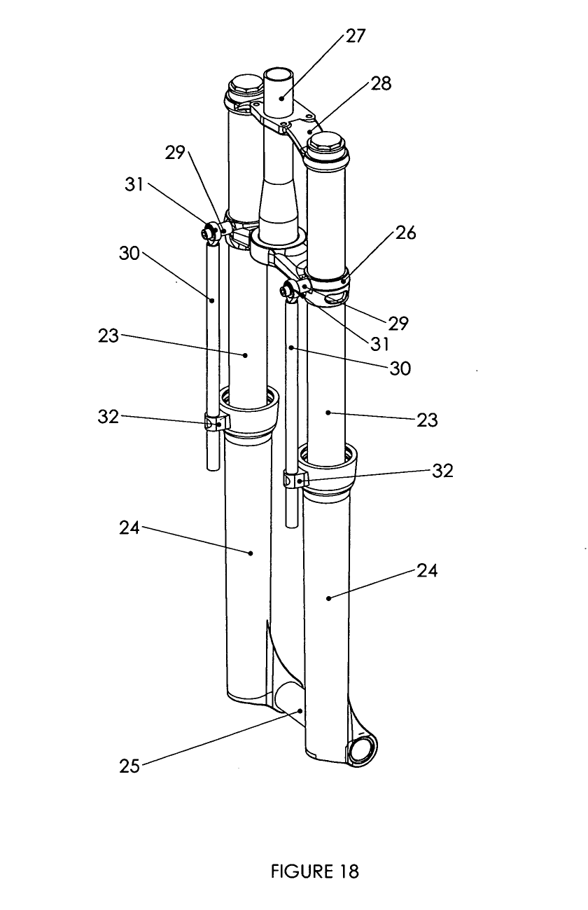

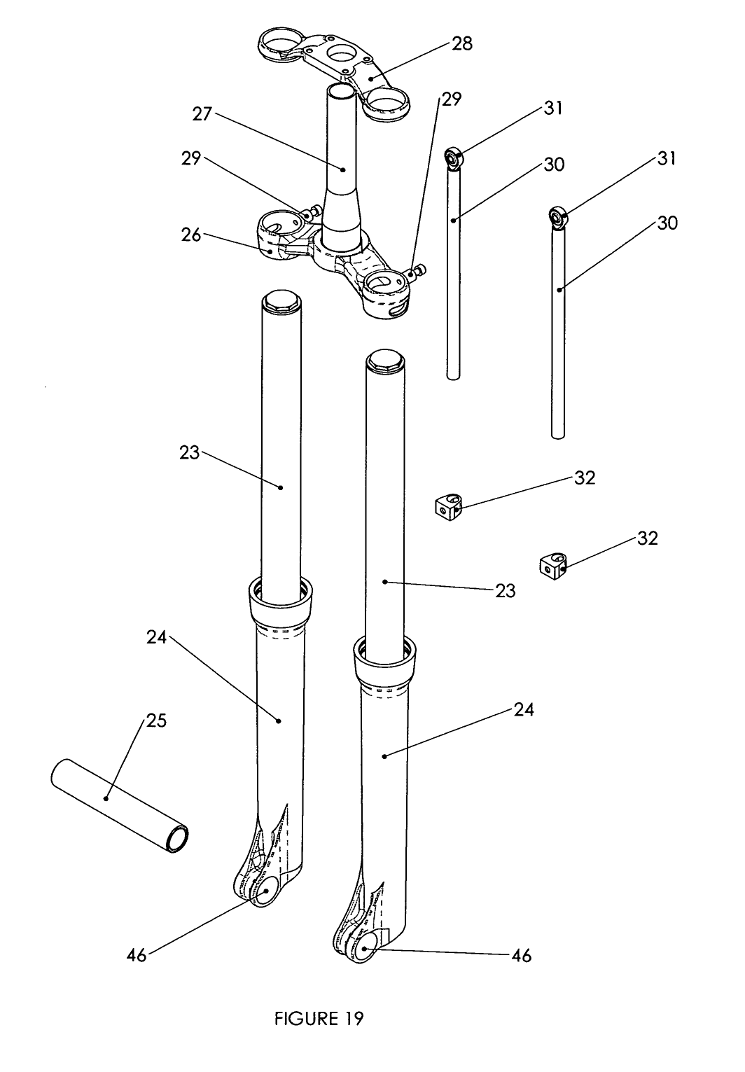

Referring next to FIGS. 17-19, illustrated is yet another alternative embodiment of the torsion brace in accordance with the invention. In this alternate embodiment, an external stiffening mechanism or torsion brace 30 can be applied to a non-inverted conventional suspension fork layout. In this embodiment, the upper stanchions 23 slide into the lower fork legs 24. In a similar fashion to an inverted fork layout, the crowns 26 and 28 clamp the upper stanchions 23 and transfer the steering forces from the upper stanchions 23 to the steerer tube 27. The axle 25 connects the two lower fork legs 24 at their lower ends and clamps the hub and wheel. Here, however, the torsional forces that need to be addressed are in the upper part of the fork assembly as opposed to the lower part of the fork assembly with the inverted suspension forks discussed above.

Accordingly, each stiffening device or torsion brace 30 works as a translating rod external to each leg 24 of the fork assembly. The torsion brace 30 preferably comprises main body or rod 47 and rod connecting end 31. The rod connecting end 31 is attached to a boss 29 which is threaded into or otherwise affixed or secured to the lower crown 26 as shown in this example, but it may optionally be attached to any point on the stanchions 23 or the crowns 26, 28. The main body of each rod 47 translates longitudinally through the respective guides 32 which are bolted or otherwise secured to each fork leg 24 as shown. The assembly of the guide 32, the rod 47, the rod connecting end 31 and the boss 29 (all together comprising torsion brace 30) helps resist torsional deflection between each stanchion 23 and its respective fork leg 24. When assembled, the stanchion 23 and the fork leg 24 cannot rotate freely even without the axle 25 installed.

During assembly of the conventional non-inverted suspension fork, the upper crown 28 typically bolts or is otherwise secured to the upper stanchions 23 and the steerer tube 27, which usually comes pre-assembled with the lower crown 26, also typically bolted or otherwise secured to upper stanchions 23 and steerer tube 27. This ensures that the upper stanchions 23 are parallel with one another and are at equal height within the crowns 26, 28. Also during assembly, the brace 30 can be installed to keep the stanchions 23 aligned and parallel to be concentric and co-axial with lower legs 24. For this, boss 29 is bolted to or otherwise affixed or secured to crown 26, while guides 32 are bolted to or otherwise affixed or secured to an upper end of the lower legs 24. Rod connecting end 31 optionally removably affixed to an upper end of rod 47. Rods 47 with rod connecting ends 31 are inserted into guides 32 and rod connecting end 31 is then removably attached to boss 29. Optionally, axle 25 may be installed and clamped into the dropout bore through holes 46 on the lower end of the lower legs 24 to keep the stanchions 23 aligned and parallel to be concentric and co-axial with lower legs 24. The fork dropouts in this embodiment are typically integral with the lower end of lower legs 24 of the fork assembly.

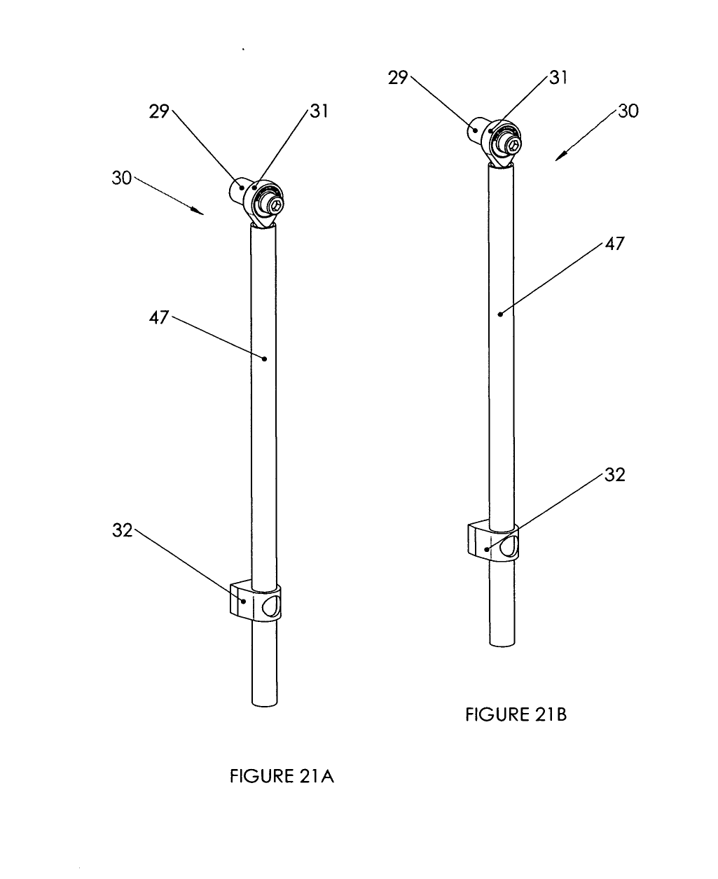

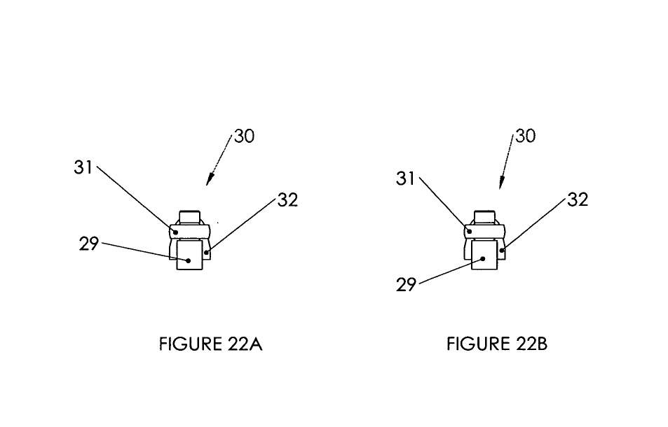

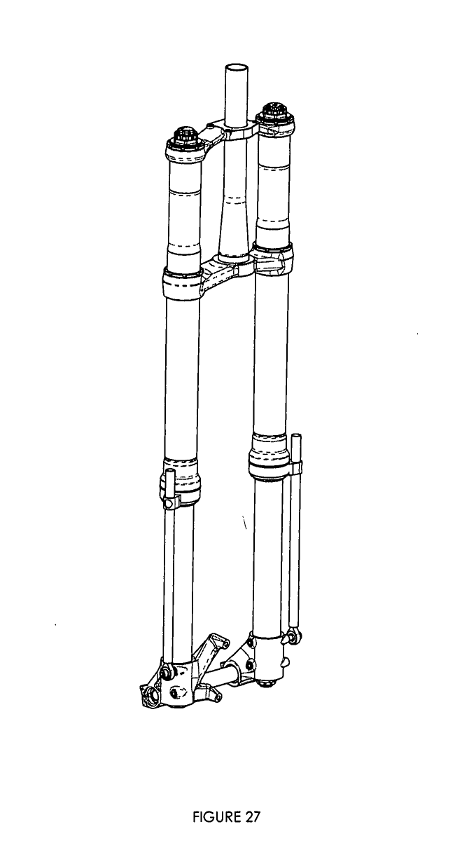

Alternatively, as depicted in FIG. 27, the brace or front fork reinforcing structure according to the embodiment depicted and described with respect to FIGS. 17-22 may be utilized with an inverted front telescoping suspension fork as shown. In particular, the brace or front fork reinforcing structure comprises first and second rigid rods, the rods being generally cylindrical and attached in parallel respectively with first and second lower legs of the fork assembly, wherein the first rod is substantially parallel to the second rod. The brace further comprises first and second lower rod connecting members for connecting lower ends of the first and second rods, respectively, to a pre-determined location proximate to lower ends of the first and second lower legs, respectively, of the fork assembly. Finally, the brace comprises first and second upper guides secured to lower ends of the first and second upper legs, respectively, of the fork assembly for slidable engagement with upper ends of the first and second rods similar to that discussed above with respect to FIGS. 17-19.

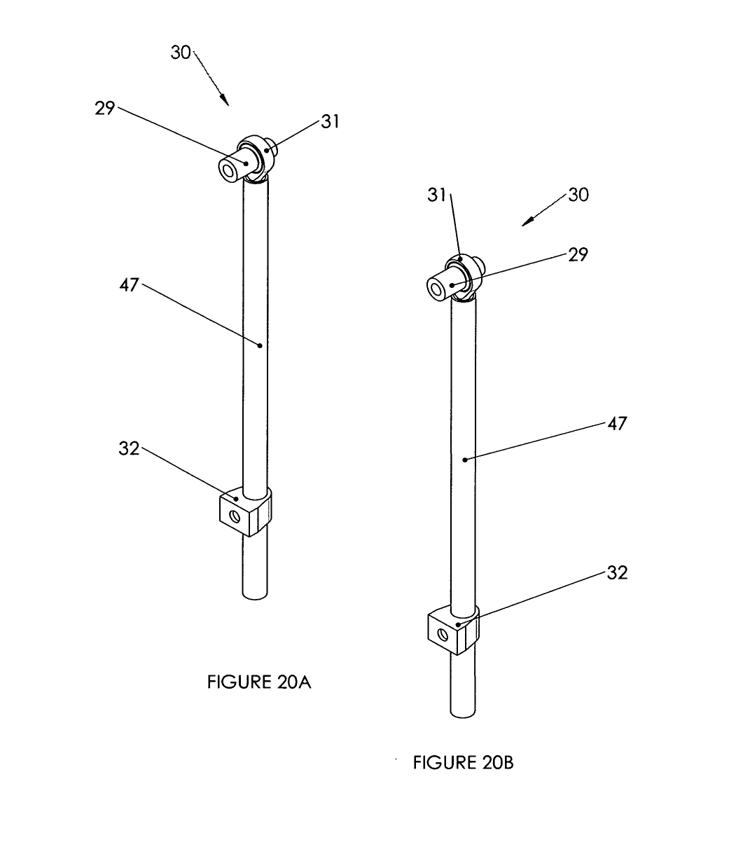

Looking now at FIGS. 20-22, shown are enlarged views of the alternative embodiment of the components for torsion brace 30 also depicted in FIGS. 17-19 in accordance with the invention. As discussed above, this alternative embodiment is for use with the upper legs of a convention non-inverted front telescoping suspension fork (as depicted in FIGS. 17-19). As shown, this embodiment of brace 30 is preferably configured as a pair of substantially parallel and substantially rod-like independent legs 47 (although other shapes and configurations can be used and are herein contemplated) connected at the upper end to rod connecting end 31, which attaches to or is secured to boss 29. Rods 47 longitudinally traverse the respective guides 32 such that during operation and use of the fork assembly only longitudinal movement is permitted. Thus, brace 30 is able to resist torsional deflection between each stanchion 23 and its respective fork leg 24 and reduce the overall flexure of the fork assembly.

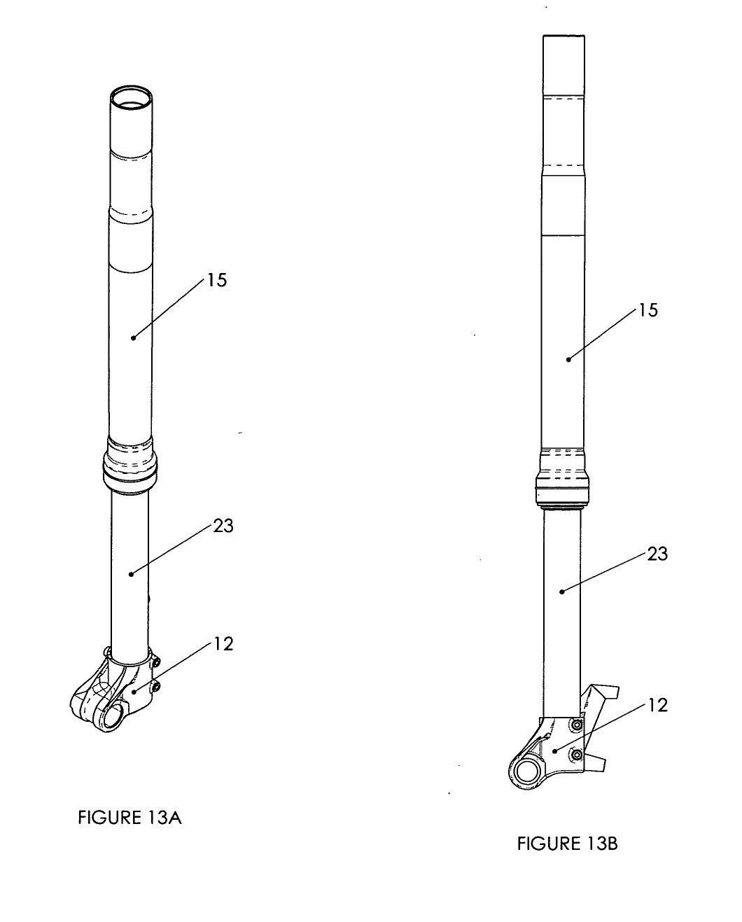

As discussed herein, it is a primary objective of the invention to provide an external means to a telescoping suspension system for increasing its torsional stiffness and consequently decreasing or reducing its flexure. To this end, disclosed herein are multiple embodiments of such external means as depicted in, for example, FIGS. 4-6, 10-12 and 17-19. By way of further example and illustration, the method by which increased torsional stiffness and decreased or reduced flexure is effectuated by torsion brace 11 depicted in FIGS. 7-12 is hereby further illustrated in FIGS. 13-16.

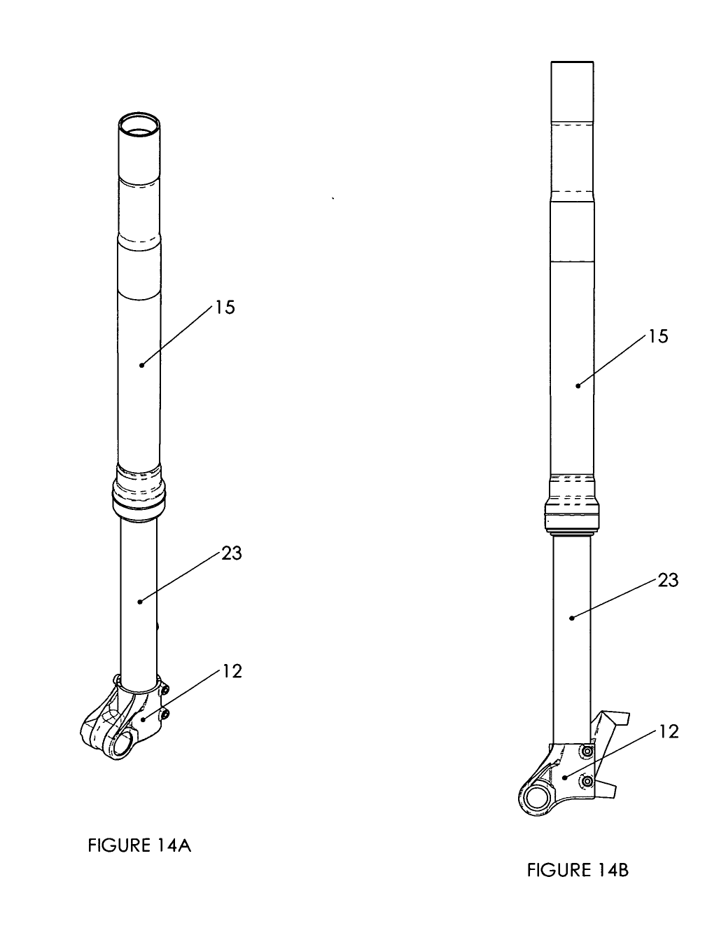

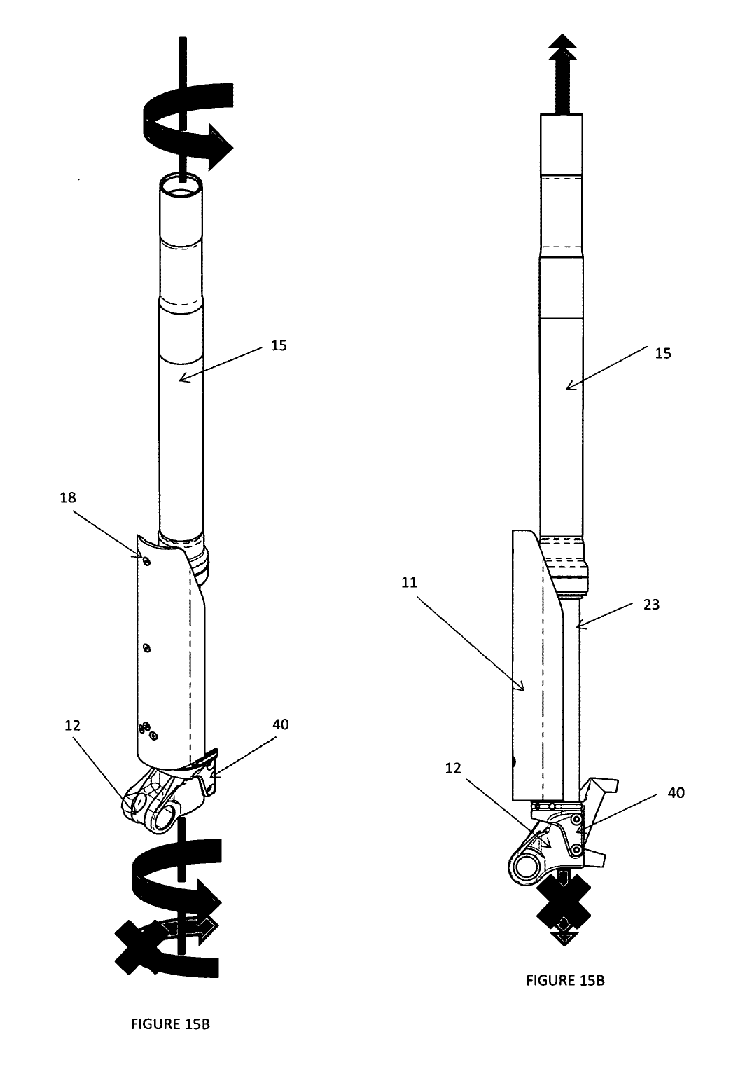

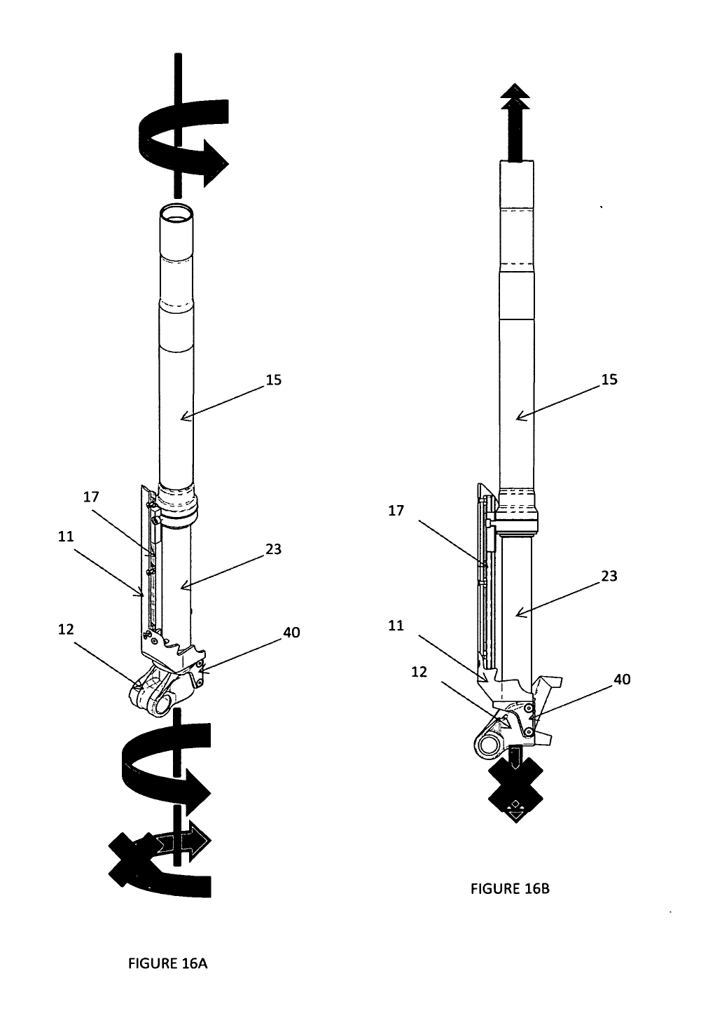

Here, FIGS. 13A-B show, respectively, front perspective and side views of the upper leg, stanchion and dropout of one leg of a typical bicycle or motorcycle front telescoping suspension fork of an inverted design layout. From FIGS. 14A-B, which show the front inverted telescoping suspension fork legs of FIGS. 13A-B, respectively, one can see from the designated arrows how they are free to rotate independently (i.e., there is no torsional or rotational bracing or stiffness provided) during longitudinal movement during use. On the other hand, when torsion brace 11 according to one of the embodiments of the invention is employed, as seen in FIGS. 15A-B, illustrating, respectively, front perspective and side views of front telescoping suspension fork legs of an inverted design layout of FIGS. 13A-B with the torsion braces shown in FIGS. 7-12, one can readily see that the front inverted telescoping suspension fork legs are not free to rotate independently during longitudinal movement while in use (see FIG. 16A-B). Accordingly, increased torsional stiffness is provided thereby reducing flexure of the inverted telescoping suspension system.

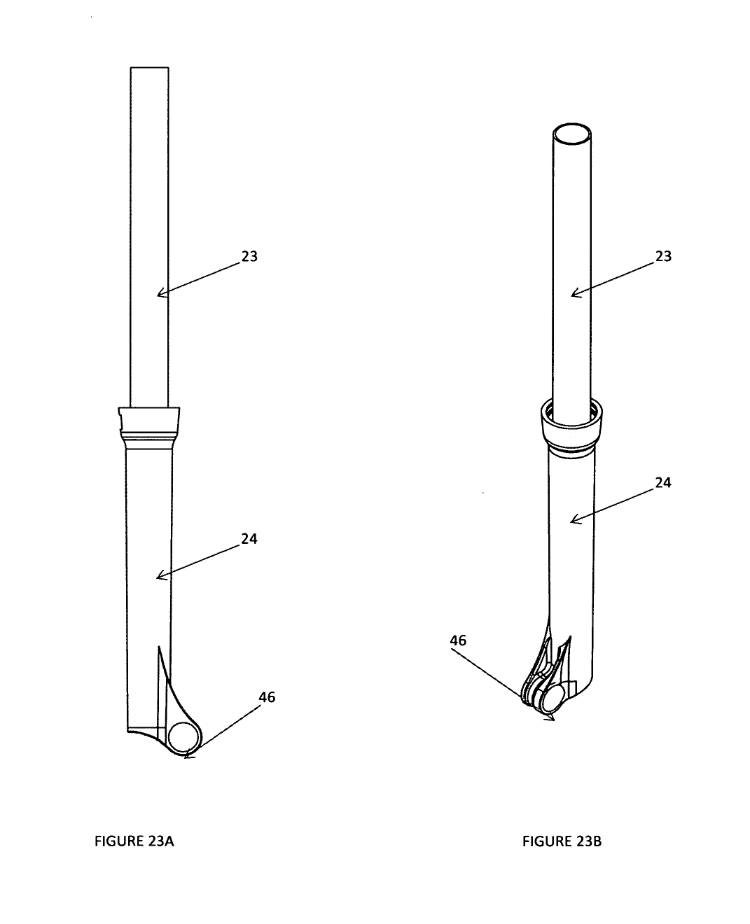

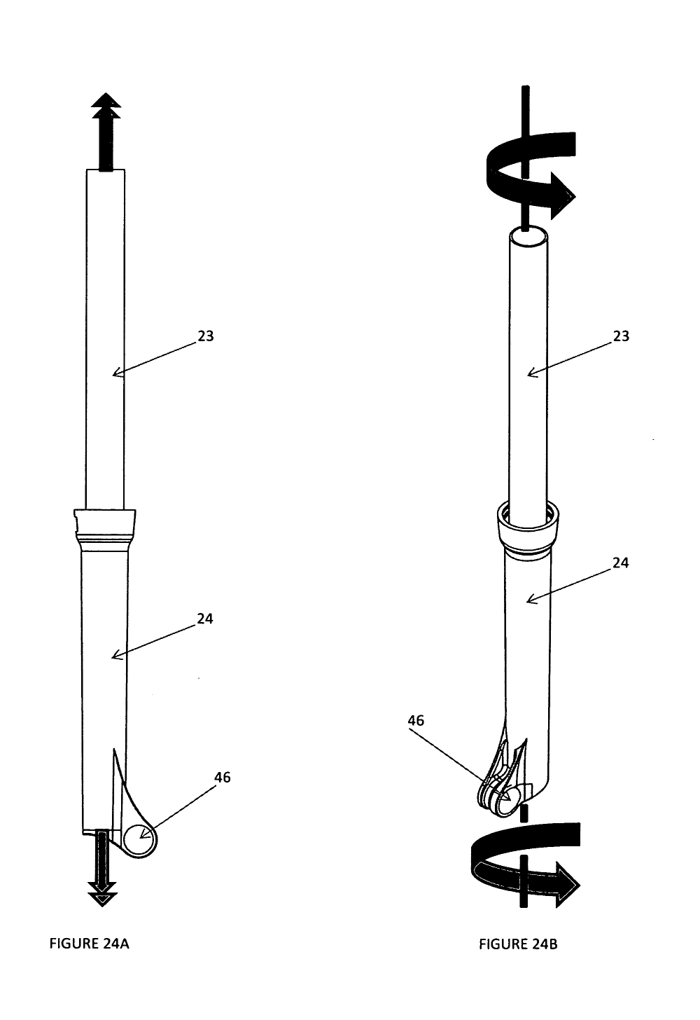

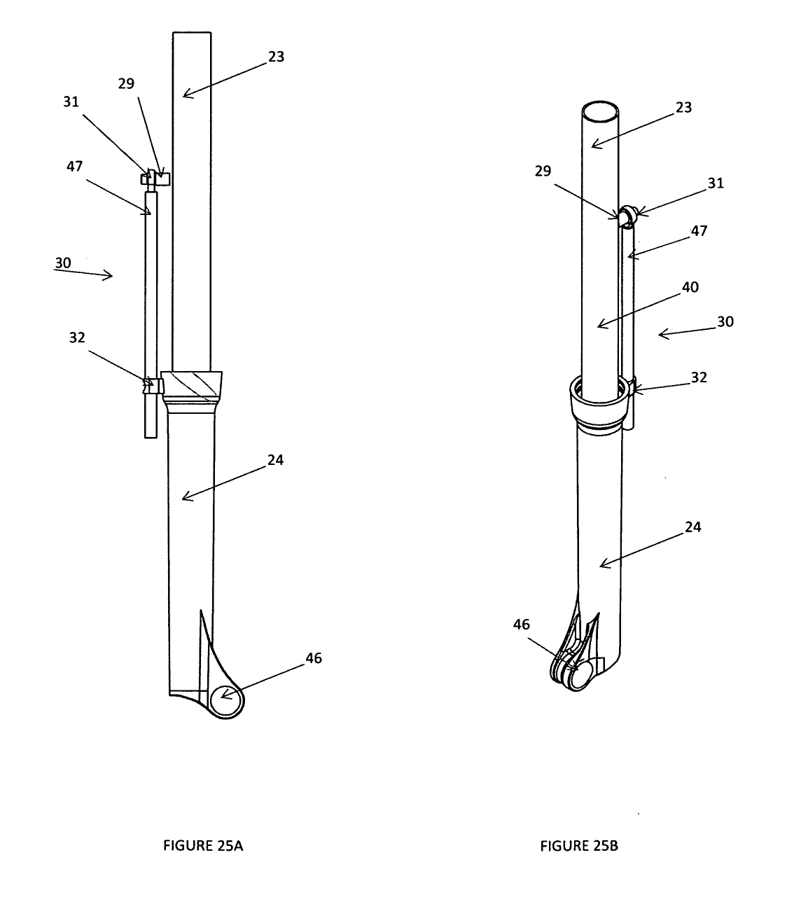

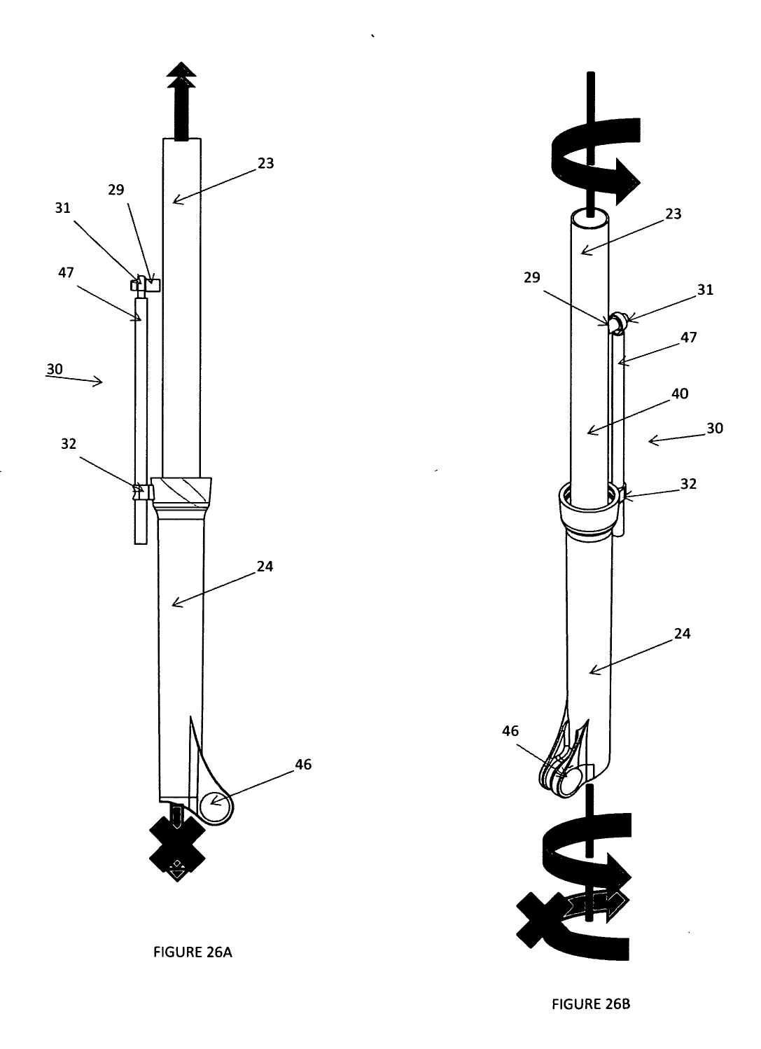

Similarly, this can be seen when torsion brace 30 according to another of the embodiments (as illustrated in FIGS. 17-22) of the invention is employed. Here, FIGS. 23A-B show, respectively, side and front perspective views of the lower leg and stanchion of one leg of a typical bicycle or motorcycle front telescoping suspension fork of an non-inverted design layout. From FIGS. 24A-B, which show the front non-inverted telescoping suspension fork legs of FIGS. 23A-B, respectively, one can see from the designated arrows how they are free to rotate independently (i.e., there is no torsional or rotational bracing or stiffness provided) during longitudinal movement during use. On the other hand, when torsion brace 30 according to the other alternative embodiment of the invention is employed, as seen in FIGS. 25A-B, illustrating, respectively, side and front perspective views of front telescoping suspension fork legs of a non-inverted design layout of FIGS. 23A-B with the torsion braces 30 shown in FIGS. 17-22, one can readily see that the front non-inverted telescoping suspension fork legs are not free to rotate independently during longitudinal movement (see FIG. 26A-B). Accordingly, increased torsional stiffness is provided thereby reducing flexure of the non-invented telescoping suspension system.

In the claims, means or step-plus-function clauses are intended to cover the structures described or suggested herein as performing the recited function and not only structural equivalents but also equivalent structures. Thus, for example, although a nail, a screw, and a bolt may not be structural equivalents in that a nail relies on friction between a wooden part and a cylindrical surface, a screw's helical surface positively engages the wooden part, and a bolt's head and nut compress opposite sides of a wooden part, in the environment of fastening wooden parts, a nail, a screw, and a bolt may be readily understood by those skilled in the art as equivalent structures.

Having described at least one of the preferred embodiments of the present invention with reference to the accompanying drawings, it is to be understood that such embodiments are merely exemplary and that the invention is not limited to those precise embodiments, and that various changes, modifications, and adaptations may be effected therein by one skilled in the art without departing from the scope or spirit of the invention as defined in the appended claims. The scope of the invention, therefore, shall be defined solely by the following claims. Further, it will be apparent to those of skill in the art that numerous changes may be made in such details without departing from the spirit and the principles of the invention. It should be appreciated that the present invention is capable of being embodied in other forms without departing from its essential characteristics.

1. A brace for a front suspension fork assembly for a two wheeled vehicle having a front wheel rotatably mounted on an axle of the wheel, said fork assembly having a pair of upper legs, a pair of lower legs, and a pair of fork dropouts for connection to the axle, said brace comprising:
first and second rigid leg members, said leg members being generally semi-cylindrical and configured for placement external to and coaxial with first and second lower legs of a suspension fork assembly, wherein said first leg member is substantially parallel with said second leg member;
first and second brackets located at lower ends of said first and second leg members, respectively, engageable with first and second dropouts, respectively, on lower ends of said first and second lower legs of said suspension fork assembly; and
an arch member having an inverted generally U-shaped configuration for connecting an upper end of said first leg member with an upper end of said second leg member;
wherein said brace is slidably engaged axially along a whole length of said front suspension fork assembly.

2. The brace according to claim 1, wherein said brace increases steering stiffness of said fork assembly by a percentage in the range of five percent (5%) to two hundred percent (200%).

3-4. (canceled)

5. The brace according to claim 1, wherein said brace further comprises a guide set comprising:
first and second guides coupled to lower ends of said first and second upper legs, respectively, of said fork assembly; and
first and second rails coupled to inner curved surfaces of said first and second leg members, respectively, of said brace;
wherein said first and second rails are respectively slidably engageable with said first and second guides.

6. The brace according to claim 1, wherein said brace further comprises a reverse arch member a substantially inverted and generally U-shaped configuration for connecting said upper end of said first leg member with said upper end of said second leg member, said reverse arch member generally extending away from said arch member.

7-10. (canceled)

11. The brace according to claim 1, wherein said brace is constructed from a material selected from the group of materials consisting of plastic, metal, composites, and carbon fiber composite.

12. The brace according to claim 1, wherein said brace is constructed of three layers of materials comprising:
a first outer layer;
a core layer; and
a second outer layer.

13. The brace according to claim 12, wherein said first and second outer layers are constructed of carbon fiber composite, and said core layer is constructed of a light density material.

14-16. (canceled)

17. A brace for a front suspension fork assembly for a two wheeled vehicle having a front wheel rotatably mounted on an axle of the wheel, said fork assembly having a pair of upper and lower legs and a pair of fork dropouts for connection to the axle, said brace comprising:
first and second rigid leg members, said leg members being generally semi-cylindrical and configured to be positioned external to and coaxial with first and second lower legs of a suspension fork assembly, wherein said first leg member is substantially parallel with said second leg member;
a guide set comprising:
first and second guides coupled to lower ends of said first and second upper legs of said fork assembly; and
first and second rails coupled to inner surfaces of said first and second leg members of said brace;
wherein said first and second rails are respectively slidably engageable with said first and second guides; and
an arch member having an inverted generally U-shaped configuration for connecting an upper end of said first leg member with an upper end of said second leg member.

18. The brace according to claim 17, wherein said brace increases steering stiffness of said fork assembly by a percentage in the range of five percent (5%) to two hundred percent (200%).

19-20. (canceled)

21. The brace according to claim 17, wherein said brace further comprises a reverse arch member having a substantially inverted and generally U-shaped configuration for connecting said upper end of said first leg member with said upper end of said second leg member, said reverse arch member generally extending away from said arch member.

22. (canceled)

23. The brace according to claim 17, wherein said brace is constructed from a material selected from the group of materials consisting of plastic, metal, composites, and carbon fiber composite.

24. The brace according to claim 17, wherein said brace is constructed of three layers of materials comprising:
a first outer layer;
a core layer; and
a second outer layer.

25. The brace according to claim 24, wherein said first and second outer layers are constructed of carbon fiber composite, and said core layer is constructed of a light density material.

26-27. (canceled)

28. A brace for a front suspension fork assembly for a two wheeled vehicle having a front wheel rotatably mounted on an axle, said fork assembly having a pair of upper and lower legs and a pair of fork dropouts for connection to the axle, said brace comprising:
first and second rigid leg members, said leg members being generally semi-cylindrical and configured to be positioned external to and coaxial with first and second lower legs of a suspension fork assembly, wherein said first leg member is substantially parallel with said second leg member; and
a guide set comprising:
first and second guides coupled to lower ends of said first and second upper legs of said fork assembly; and
first and second rails coupled to inner surfaces of said first and second leg members of said brace;
wherein said first and second rails are respectively slidably engageable with said first and second guides.

29. The brace according to claim 28, wherein said brace further comprises first and second connecting brackets positioned respectively on lower ends of said first and second leg members for connecting said brace to first and second dropouts on lower ends of said first and second lower legs of said suspension fork assembly.

30-31. (canceled)

32. The brace according to claim 29, wherein said brackets are integral with said brace.

33. The brace according to claim 29, wherein said brace increases steering stiffness of said fork assembly by a percentage in the range of five percent (5%) to two hundred percent (200%).

34-36. (canceled)

37. The brace according to claim 29, wherein said legs of said brace are constructed from a material selected from the group of materials consisting of plastic, metal, composites, and carbon fiber composite.

38. The brace according to claim 29, wherein said legs of said brace are constructed of three layers of materials comprising:
a first outer layer;
a core layer; and
a second outer layer.

39. The brace according to claim 38, wherein said first and second outer layers are constructed of carbon fiber composite, and said core layer is constructed of a light density material.

40-54. (canceled)
